(19) United States
(12) Patent Application Publication
(10) Pub. No.: US 2017/0345029 A1
(43) Pub. Date: Nov. 30, 2017

(54) USER ACTION DATA PROCESSING METHOD AND DEVICE

(71) Applicants: BEIJING JINGDONG SHANGKE INFORMATION TECHNOLOGY CO., LTD., Haidian District, Beijing (CN); BEIJING JINGDONG CENTURY TRADING CO., LTD., Beijing (CN)

(72) Inventors: Haiyong CHEN, Haidian District, Beijing (CN); Chuan MOU, Haidian District, Beijing (CN); Zhifeng XING, Haidian District, Beijing (CN)

(21) Appl. No.: 15/535,134

(22) PCT Filed: Dec. 8, 2015
(86) PCT No.: PCT/CN2015/096631

§ 371 Date: Jun. 12, 2017

(30) Foreign Application Priority Data
Dec. 12, 2014 (CN) 201410769144.3

(51) Int. Cl. G06Q 30/02; G06N 99/00; G06F 17/30

(52) U.S. Cl. CPC G06Q 30/0201; G06F 17/30876; G06N 99/005

(57) ABSTRACT

A method and device for determining whether a user who has not ordered a commodity has a demand for the commodity. The method comprises calculating a number of actions directed at the commodity by users in a preselected time period that is not ordered in a preselected time period and a number of users purchasing the commodity after the preselected time period; establishing a training set based on the numbers and a model corresponding to the training set. The model has an input value of the number of actions directed to the commodity by a user and an output value of whether the user purchases the specified commodity. The method also includes calculating the number of actions of an object user who has not ordered in a preset time period and inputting the number into the model as the input value to obtain the output value of the model.

### TECHNICAL FIELD

The invention relates to the technical field of computer technology, and in particular to a method and device for processing user action data.

### BACKGROUND ART

In an e-commerce platform, sales staff are generally required to quantify a demand for a commodity to thereby determine an inventory and replenishment strategy of the commodity. The quantification of the commodity demand is generally to calculate the number of users demanding the commodity. A current manner is to approximately replace a commodity demand quantity with the number of users who order the commodity. In this manner, the number of orders of the commodity in a time period, e.g., one week, is counted in accordance with a commodity identifier, and the number of orders is used as the weekly demand quantity for the commodity. This manner does not consider demands of users who have not placed orders, and easily results in relatively small data for prediction of the demand quantity.

Another current manner is to consider the number of views of the user, for a specified commodity, the number of orders in a historical time period, e.g., one week, is counted, in addition, the number of users whose number of views of the commodity reaches a preset value is further counted, and a sum of the number of the users and the number of the orders is used as the demand quantity for the commodity. This manner is still not sufficiently accurate, for when the user views a certain commodity, no view will be further performed if it is found that the commodity shows no inventory, which results in that the number of views cannot reach the preset value so that the count of the demand quantity is still relatively small.

Thus, there is a need for a method to determine the user's demand for the commodity, and the demand quantity for the commodity can be determined on this basis.

### SUMMARY OF THE INVENTION

In view of the above, the invention provides a method and device for processing user action dada, which assists in judging whether a user who has not placed an order has a demand, and a commodity demand quantity can be determined on this basis.

In order to achieve the above object, according to one aspect of the invention, a method for processing user action dada is provided.

The method for processing user action dada according to the invention comprises: for a specified commodity not ordered by a plurality of users in a preselected time period, counting respectively the numbers of actions directed at the commodity by the respective users in the preselected time period, and recording whether the respective users purchase the commodity after the preselected time period; establishing a training set in accordance with data of the plurality of users, in a model corresponding to the training set, an input value being the number of actions directed at the specified commodity by the user, and an output value being whether the user purchases the specified commodity; conducting a linear regression training on the training set to determine a plurality of parameters of the training set to thereby obtain the model; and counting the number of actions of an object user who has not placed an order in a preset time period, and inputting the number into the model as the input value to obtain the output value of the model.

Optionally, the model is an equation as follows: Y=β₀+β₁X₁+β₂X₂+ . . . +βₙXₙ+ε; wherein a value of Y corresponds to whether the user purchases the commodity, ε represents a preset constant, β₀, β₁, . . . βₙ represent weight coefficients, and for X₁, X₂, . . . Xₙ, when a value of the natural number subscript n corresponds to the number of times of actions directed at the commodity by the user, Xₙ takes a first preset value, or otherwise takes a second preset value.

Optionally, the linear regression training adopts a gradient descent method.

Optionally, after obtaining the model, the method further comprises: counting the numbers of actions of a plurality of object users in the preset time period, and inputting respectively the numbers into the model as input values to obtain a plurality of output values of the model; and determining the number of users who purchase the specified commodity among the plurality of object users in accordance with the plurality of output values.

According to another aspect of the invention, a device for processing user action data is provided.

The device for processing user action dada according to the invention, comprises: a counting module for, for a specified commodity not ordered by a plurality of users in a preselected time period, counting respectively the numbers of actions directed at the commodity by the respective users in the preselected time period; a recording module for recording whether the respective users purchase the specified commodity after the preselected time period; a training module for conducting a linear regression training on a training set to determine a plurality of parameters of the training set to thereby obtain a model corresponding to the training set; the training set being established in accordance with data of the plurality of users, and in the model, an input value being the number of actions directed at the commodity by the user, and an output value being whether the user purchases the specified commodity; and a calculating module for counting the number of actions of an object user in a preset time period, and inputting the number into the model as the input value to obtain the output value of the model.

Optionally, the model is an equation as follows: Y=β₀β₁X₁+β₂X₂+ . . . +βₙXₙ+ε; wherein a value of Y corresponds to whether the user purchases the specified commodity, ε represents a preset constant, β₀, β₁, . . . βₙ represent weight coefficients, and for X₁, X₂, . . . Xₙ, when a value of the natural number subscript n corresponds to the number of times of actions directed at the commodity by the user, Xₙ takes a first preset value, or otherwise takes a second preset value.

Optionally, the linear regression training adopts a gradient descent method.

Optionally, the calculating module is further used for: counting the numbers of actions of a plurality of object users who have not placed orders in the preset time period, and inputting respectively the numbers into the model as input values to obtain a plurality of output values of the model; and determining the number of users who purchase the specified commodity among the plurality of object users in accordance with the plurality of output values.

In accordance with the technical solutions of the invention, historical data is adopted to conduct a model training to obtain a model, and then the model is used to predict whether a user who has not placed an order will place an order later, which can achieve a quite accurate prediction effect in a case that the training set is comparatively larger, and assists in accurately determining the demand quantity for the commodity.

### BRIEF DESCRIPTION OF THE DRAWINGS

Figures are used to better understand the invention, and do not form improper limitations of the invention. Wherein:

FIG. 1 is a schematic diagram of main steps of a method for processing user action data according to an embodiment of the invention; and

FIG. 2 is a schematic diagram of main modules of a device for processing user action data according to an embodiment of the invention.

### DETAILED DESCRIPTION

Exemplary embodiments of the invention, including various details of the embodiments of the invention, are described below by taking the figures into consideration to facilitate understanding, and the embodiments should be considered as exemplary ones only. Thus, those skilled in the art should recognize that various changes and modifications can be made with respect to the embodiments described herein without departing from the scope and spirit of the invention. Similarly, for clarity and conciseness, descriptions of common functions and structures are omitted in the descriptions below.

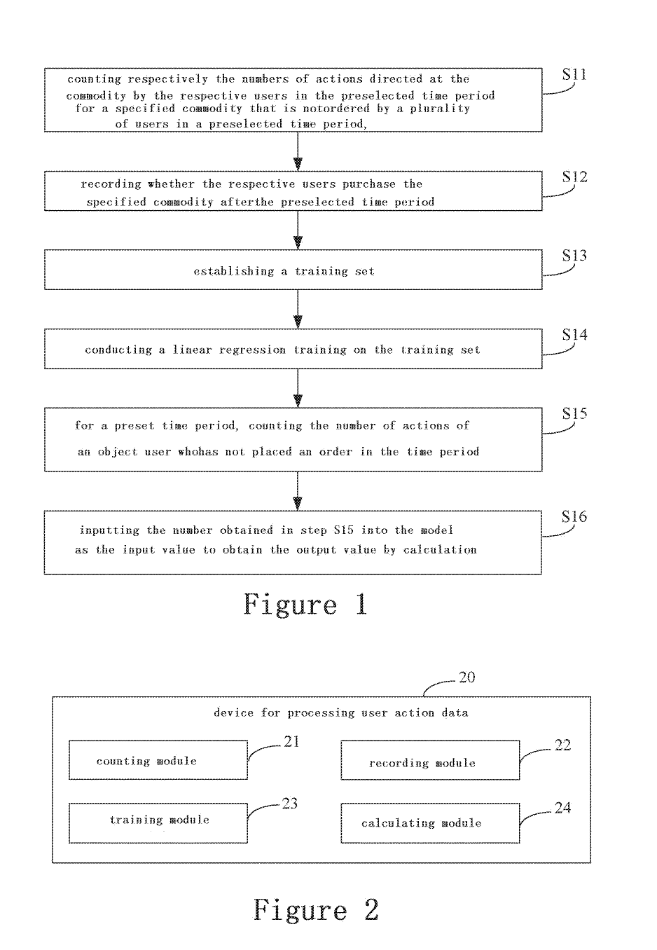

In the embodiment of the invention, modeling is conducted with respect to an action directed at a commodity by a user to predict whether the user has a demand for a commodity not ordered but viewed. Descriptions are given below by taking FIG. 1 into consideration. FIG. 1 is a schematic diagram of main steps of a method for processing user action data according to an embodiment of the invention.

Step S11: for a specified commodity not ordered by a plurality of users in a preselected time period, counting respectively the numbers of actions directed at the commodity by the respective users in the preselected time period. The above-mentioned action directed at the commodity by the user can be one type of action, e.g., directly viewing the commodity; and had better be multiple actions of the user that are comprehensively counted, e.g., directly viewing the commodity, searching for the commodity through a search engine, and accessing the commodity through a search portal.

Step S12: recording whether the respective users purchase the specified commodity after the preselected time period. The above-mentioned two steps are in a data preparation stage, and obtain data of a training set in accordance with historical data. The preselected time period herein may be one day, several days or a longer time, and is selected according to actual conditions.

Step S13: establishing a training set. The training set is obtained in accordance with the data obtained in the above-mentioned step. An output value of the model corresponding to the training set represents whether the user purchases the specified commodity. For example, the output value is set to 0 to represent that the user has not placed an order, and the output value is set to 1 to represent that the user has placed an order. Certainly, other numerical values can be also adopted. An input value of the model is the number of actions directed at the commodity by the user. For example, if the number of views is adopted, an upper limit of the number of views can be set to 300, e.g., if the number of views of a certain user is 20, a vector [X₁, X₂, . . . Xₙ] corresponding to the user is [0, 0, . . . 1, . . . 0], where only the value of the 20^{th} element is 1, and the values of the other elements are 0. The 20^{th} element herein is determined in accordance with that the number of views is 20. Furthermore, if the three actions, i.e., directly viewing the commodity, searching for the commodity through a search engine, and accessing the commodity through a search portal, are adopted, upper limits of the three actions can be respectively set to 300, vectors corresponding to the respective actions are connected to form a vector having a dimensionality of 900, and a position of an element being not 0 in the vector is set to one consistent with the number of actions, e.g., if the number of direct views of the user is 10, the search engine searches for the commodity for 5 times, and the commodity is accessed for 3 times through the search portal, in the vector having a dimensionality of 900, only the 10^{th}, the 305^{th} and the 603^{rd} elements are 1, and the other elements are 0.

The model corresponding to the training set can adopt an equation as follows: Y=β₀+β₁X₁+β₂X₂+ . . . +βₙXₙ+ε; wherein Y is the output value, and a value thereof corresponds to whether the user purchases the commodity, e.g., Y is 0, which represents that the user has not placed an order, and Y is 1, which represents that the user has placed an order. ε represents a preset constant for adjusting the accuracy of the model. β₀, β₁, . . . βₙ represent weight coefficients, and X₁, X₂, . . . Xₙ are elements in the vector. In accordance with the descriptions above, when a value of the natural number subscript n corresponds to the number of times of actions directed at the commodity by the user, Xₙ takes a first preset value such as 1, or otherwise takes a second preset value such as 0.

Step S14: conducting a linear regression training on the training set. This step is to determine the weight coefficients β₀, β₁, . . . βₙ. A gradient descent method can be specifically adopted. After the weight coefficients are determined, the model is determined therewith.

Step S15: for a preset time period, counting the number of actions of an object user who has not placed an order in the time period. In this step, the number of actions where the user has the actions directed at a certain determined commodity in the preset time period but has not actually placed an order in the time period is inspected.

Step S16: inputting the number obtained in Step S15 into the model as the input value to obtain the output value by calculation. The output value is just the value of Y, and represents that a result of whether the user has placed an order is “YES” or “NO”. It can be seen that for a user who has not placed an order, whether the user places an order can be predicted by using the model obtained in the embodiment. The larger the training set is, the more accurate the result of prediction is.

For a specified commodity on an e-commerce platform, the above-mentioned steps can be used to predict whether each user viewing the commodity will place an order, and the coming demand quantity for the commodity can be predicted in accordance with the obtained result.

FIG. 2 is a schematic diagram of main modules of a device for processing user action data according to an embodiment of the invention. As shown in FIG. 2, a device 20 for processing user action dada according to the embodiment of the invention mainly comprises a counting module 21, a recording module 22, a training module 23, and a calculating module 24.

The counting module 21 is used for, for a specified commodity not ordered by a plurality of users in a preselected time period, counting respectively the numbers of actions directed at the commodity by the respective users in the preselected time period. The recording module 22 is used for recording whether the respective users purchase the specified commodity after the preselected time period. The training module 23 is used for conducting a linear regression training on a training set to determine a plurality of parameters of the training set to thereby obtain a model corresponding to the training set; the training set being established in accordance with data of the plurality of users, and in the model, an input value being the number of actions directed at the commodity by the user, and an output value being whether the user purchases the specified commodity. The calculating module 24 is used for counting the number of actions of an object user in a preset time period, and inputting the number into the model as the input value to obtain the output value of the model.

The calculating module 24 can be further used for: counting the numbers of actions of a plurality of object users who have not placed orders in the preset time period, and inputting respectively the numbers into the model as input values to obtain a plurality of output values of the model; and determining the number of users who purchase the specified commodity among the plurality of object users in accordance with the plurality of output values.

In accordance with the technical solutions of the invention, historical data is adopted to conduct a model training to obtain a model, and then the model is used to predict whether a user who has not placed an order will place an order later, which can achieve a quite accurate prediction effect in a case that the training set is comparatively larger, and assists in accurately determining the demand quantity for the commodity.

The contents above describe the basic principle of the invention by taking the embodiments into consideration, and in the device and method of the invention, it is apparent that respective parts or respective steps can be decomposed and/recombined. These decompositions and/or recombinations should be considered as equivalent solutions of the invention. Moreover, steps for performing the above-mentioned series of treatments can be naturally chronologically performed in accordance with the described order, but are not necessarily chronologically performed. Some steps can be parallel and performed independently of each other.

The above-mentioned embodiments do not form limitations of the scope of protection of the invention. Those skilled in the art should understand that depending on design requirements and other factors, various modifications, combinations, sub-combinations and substitutions may occur. Any modification, equivalent substitution, improvement and the like made within the spirit and principle of the invention should be included in the scope of protection of the invention.

1. A method for processing user action dada, comprising:
counting, with a device, respectively the numbers of actions directed at the commodity by the respective users in the preselected time period for a specified commodity that is not ordered by a plurality of users in a preselected time period, and recording whether the respective users purchase the commodity after the preselected time period;
establishing, with the device, a training set in accordance with data of the plurality of users, in a model corresponding to the training set, an input value being the number of actions directed at the specified commodity by the user, and an output value being whether the user purchases the specified commodity;
conducting, with the device, a linear regression training on the training set to determine a plurality of parameters of the training set to thereby obtain the model;
counting, with the device, the number of actions of an object user who has not placed an order in a preset time period;
inputting, with the device, the number into the model as the input value; and
outputting, with the device, the output value of the model.

2. The method according to claim 1, wherein the model is an equation as follows:
Y=β₀+β₁X₁+β₂X₂+. . . +βₙXₙ+ε;
wherein a value of Y corresponds to whether the user purchases the commodity, ε represents a preset constant, β₀, β₁, . . . βₙ represent weight coefficients, and for X₁, X₂, . . . Xₙ, when a value of the natural number subscript n corresponds to the number of times of actions directed at the commodity by the user, Xₙ takes a first preset value, or otherwise takes a second preset value.

3. The method according to claim 1, wherein the linear regression training adopts a gradient descent method.

4. The method according to claim 1, wherein after obtaining the model, the method further comprises:
counting the numbers of actions of a plurality of object users in the preset time period, and inputting respectively the numbers into the model as input values to obtain a plurality of output values of the model; and
determining the number of users who purchase the specified commodity among the plurality of object users in accordance with the plurality of output values.

5. A system for processing user action data, comprising:
a device configured to
count respectively the numbers of actions directed at the commodity by the respective users in the preselected time period for a specified commodity that is not ordered by a plurality of users in a preselected time period,
record whether the respective users purchase the specified commodity after the preselected time period,
conduct a linear regression training on a training set to determine a plurality of parameters of the training set to thereby obtain a model corresponding to the training set; the training set being established in accordance with data of the plurality of users, and in the model, an input value being the number of actions directed at the commodity by the user, and an output value being whether the user purchases the specified commodity,
count the number of actions of an object user in a preset time period,
input the number into the model as the input value, and
output the output value of the model.

6. The system according to claim 5, wherein the model is an equation as follows:
Y=β₀+β₁X₁+β₂X₂+ . . . +βₙXₙ+ε;
wherein a value of Y corresponds to whether the user purchases the specified commodity, represents a preset constant, β₀, β₁, . . . βₙrepresent weight coefficients, and for X₁, X₂, . . . Xₙ, when a value of the natural number subscript n corresponds to the number of times of actions directed at the commodity by the user, Xₙ takes a first preset value, or otherwise takes a second preset value.

7. The system according to claim 5, wherein the linear regression training adopts a gradient descent method.

8. The system according to claim 5, wherein the device is further configured to
count the numbers of actions of a plurality of object users who have not placed orders in the preset time period, and inputting respectively the numbers into the model as input values to obtain a plurality of output values of the model,
determine the number of users who purchase the specified commodity among the plurality of object users in accordance with the plurality of output values.
